(19) United States
(12) Patent Application Publication
(10) Pub. No.: US 2021/0272070 A1
(43) Pub. Date: Sep. 2, 2021

(54) SCHEDULE ADJUSTMENT DEVICE, SCHEDULE ADJUSTMENT SYSTEM, AND SCHEDULE ADJUSTMENT METHOD

(71) Applicant: HITACHI, LTD., Tokyo (JP)

(72) Inventor: Hideya YOSHIUCHI, Tokyo (JP)

(73) Assignee: HITACHI, LTD., Tokyo (JP)

(21) Appl. No.: 17/163,728

(22) Filed: Feb. 1, 2021

(30) Foreign Application Priority Data
Feb. 28, 2020 (JP) 2020-033459

(51) Int. Cl. G06Q 10/10; H04L 29/08

(52) U.S. Cl. CPC G06Q 10/1095; H04L 67/306; H04L 67/325

(57) ABSTRACT

The present invention provides a schedule adjustment device that automates schedule management without relying on a person's past action history.

The schedule adjustment device generating a schedule adjustment plan from schedule information indicating a schedule of a user includes: a storage device that stores schedule template information indicating a template of the schedule; and a control section that compares the schedule information with the schedule template information and generates the schedule adjustment plan.

### BACKGROUND OF THE INVENTION

### 1. Field of the Invention

The present invention relates to a schedule adjustment device, a schedule adjustment system, and a schedule adjustment method.

### 2. Description of the Related Art

The Internet of Things (IoT) technology, which connects any apparatus to the Internet and provides various services, is becoming widely used. As the number of apparatuses connected to the Internet is rapidly increasing, it is highly demanded that the action plan of a person be inferred by various apparatuses in order to optimize the person's actions.

Actions of a user are done in public places, such as schools and companies, or in private places, such as homes and places visited on holidays. In the public places, the user acts in collaboration with other persons. In the private places, the user is able to freely act during a relatively long period of time. The user usually registers and manages the user's schedule of activities in all the above-mentioned places. The user's schedule changes from moment to moment. Further, there are many cases where the determination of the user's schedule is dependent on the availability of the other persons and the reservation, for example, of related equipment and services.

In view of the above circumstances, a technology for automating the generation of a schedule is proposed in order to reduce the time required for schedule management (refer to Japanese Patent No. 2993123 (WO 96/017315), U.S. Pat. No. 9,983,015, and JP-2015-079375-A).

Technologies described in Japanese Patent No. 2993123 (WO 96/017315), U.S. Pat. No. 9,983,015, and JP-2015-079375-A extract information about user preferences, for example, from a past action history and a lifelog, and implement functions, for example, of suggesting a driving route and making automatic schedule adjustments.

However, when schedule management is automated based on the results of analysis of a person's action history, it is impossible to handle a use case not dependent on a person's past action history. As a result, flexibility and convenience are insufficient.

The present invention provides a schedule adjustment device that automates schedule management without relying on the person's past action history.

### SUMMARY OF THE INVENTION

According to an aspect of the present invention, there is provided a schedule adjustment device that generates a schedule adjustment plan from schedule information indicating a schedule of a user. The schedule adjustment device includes a storage device and a control section. The storage device stores schedule template information that indicates a template of the schedule. The control section compares the schedule information with the schedule template information and generates the schedule adjustment plan.

According to another aspect of the present invention, there is provided a schedule adjustment system that is formed by connecting a schedule management terminal to a schedule adjustment server through a network. The schedule management terminal stores schedule information that indicates a schedule of a user. The schedule adjustment server stores schedule template information indicating a template of the schedule, compares the schedule information with the schedule template information, and generates the schedule adjustment plan.

According to yet another aspect of the present invention, there is provided a schedule adjustment method for generating a schedule adjustment plan from schedule information indicating a schedule of a user, and presenting the generated schedule adjustment plan to the user. The schedule adjustment method includes: a storage step of storing schedule template information indicative of a template of the schedule; a schedule adjustment plan generation step of comparing the schedule information with the stored schedule template information and generating the schedule adjustment plan; and a display step of displaying the schedule adjustment plan.

According to an aspect of the present invention, the schedule adjustment device is able to automate schedule management without relying on the person's past action history.

### BRIEF DESCRIPTION OF THE DRAWINGS

FIG. 1 is a block diagram illustrating an example of a schedule adjustment system according to an embodiment of the present invention;

FIG. 2 is a block diagram illustrating an example structure of a schedule management server;

FIG. 3 is a block diagram illustrating an example structure of data managed by the schedule management server;

FIG. 4 is a block diagram illustrating an example structure of a schedule management terminal;

FIG. 5 is a block diagram illustrating an example structure of data managed by the schedule management terminal;

FIG. 6 is a block diagram illustrating an example structure of a schedule adjustment server;

FIG. 7 is a block diagram illustrating an example structure of data managed by the schedule adjustment server;

FIG. 8 is a time sequence diagram illustrating an example of a schedule adjustment process;

FIG. 9 is a time sequence diagram illustrating an example of the schedule adjustment process;

FIG. 10 is a flowchart illustrating an example of the schedule adjustment process;

FIG. 11 is a flowchart illustrating an example of the schedule adjustment process;

FIG. 12 is a diagram illustrating an example concept of the degree of schedule match;

FIG. 13 is a flowchart illustrating an example of the schedule adjustment process;

FIG. 14 is a flowchart illustrating an example of the schedule adjustment process;

FIG. 15 is a flowchart illustrating an example of the schedule adjustment process; and

FIG. 16 depicts a user interface in order to illustrate an example of the schedule adjustment process.

### DESCRIPTION OF THE PREFERRED EMBODIMENT

An embodiment of the present invention will now be described with reference to the accompanying drawings.

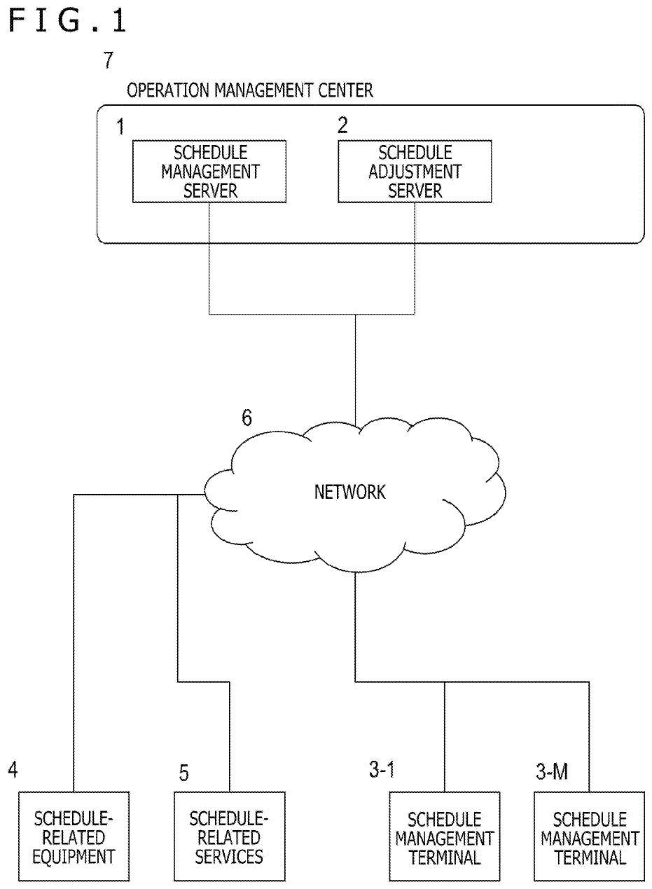

FIG. 1 illustrates an example configuration of a schedule adjustment system according to the embodiment of the present invention.

The schedule adjustment system includes a schedule management server 1, a schedule adjustment server 2, schedule management terminals (3-1 to 3-M), schedule-related equipment 4, and schedule-related services 5. The schedule management server 1 provides centralized management of all schedules of users. The schedule adjustment server 2 automatically adjusts the schedules of the users. The schedule management terminals (3-1 to 3-M) are used by the users in order to manipulate the schedules. The schedule-related equipment 4 and the schedule-related services 5 are required for schedule execution. The above component elements are interconnected through a network 6. The schedule management server 1 manages the schedules of a plurality of users, and the users each possess a schedule management terminal and manipulate the schedules. The schedule-related equipment and the schedule-related services are various facilities, equipment, and services required for schedule execution. The equipment corresponds, for example, to meeting rooms and apparatuses such as projectors, and the services correspond, for example, to restaurant reservations.

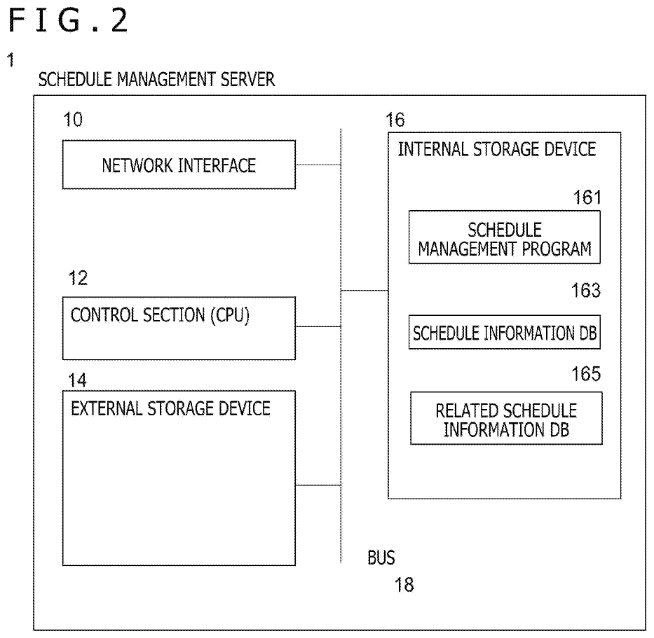

Devices included in the schedule adjustment system will now be described in detail. FIG. 2 illustrates an example device structure of the schedule management server 1.

The schedule management server 1 includes a control section (CPU) 12, a memory or other internal storage device 16, a hard disk or other external storage device 14, and a network interface 10. These component elements are connected to a bus 18. The schedule management server 1 communicates with the outside through the network interface 10. The internal storage device 16 stores a schedule management program 161, a schedule information database (DB) 163, and a related schedule information DB 165. The schedule management program 161 implements schedule management functions such as schedule registration, update, and notification. The schedule information DB 163 manages information about, for example, the start time, end time, and contents of the schedules. The related schedule information DB 165 manages the schedules of persons and apparatuses related to the users.

The above-described databases may be stored in the external storage device 14 in consideration, for example, of the scale, data volume, and response speed of the schedule adjustment system. These databases are read and written by the schedule management program 161 installed in the internal storage device 16. The schedule management functions are implemented when the control section (CPU) 12 accesses the schedule management program 161 stored in the internal storage device 16.

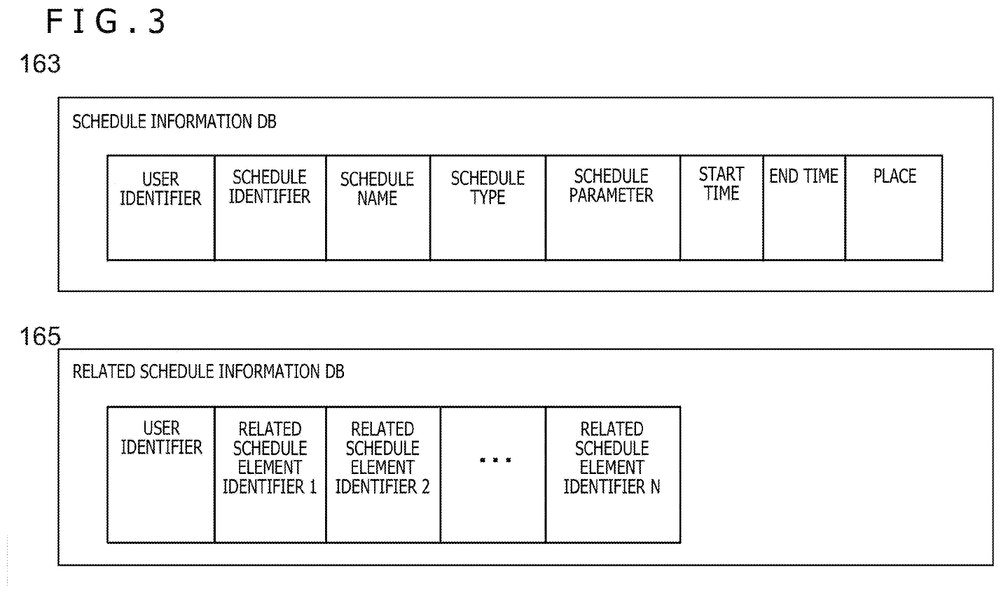

FIG. 3 illustrates an example structure of the databases existing in the internal storage device 16 of the schedule management server 1.

The schedule information DB 163 is a database for managing information about a schedule of a user. The schedule information DB 163 contains a user identifier, a schedule identifier, a schedule name, a schedule type, the start time and end time of a schedule, a schedule execution place, and a schedule parameter. The user identifier uniquely identifies a user. The schedule identifier uniquely identifies a schedule. The schedule name clearly indicates the contents of the schedule. The schedule type indicates whether the schedule relates to a human target or a nonhuman target such as an apparatus or a service. The schedule parameter is descriptive of features of the schedule.

The related schedule information DB 165 is a database for managing information that a user uses to manage the schedules of other users and apparatuses related to the user. The related schedule information DB 165 contains a user identifier and related schedule element identifiers. The user identifier uniquely identifies the user. The related schedule element identifiers uniquely identify the related other users, apparatuses, and services. In most cases, the related other users are socially related users. In a business scene, the related other users are staff members in the same department of the same company as the user. In a family scene, the related other users are family members.

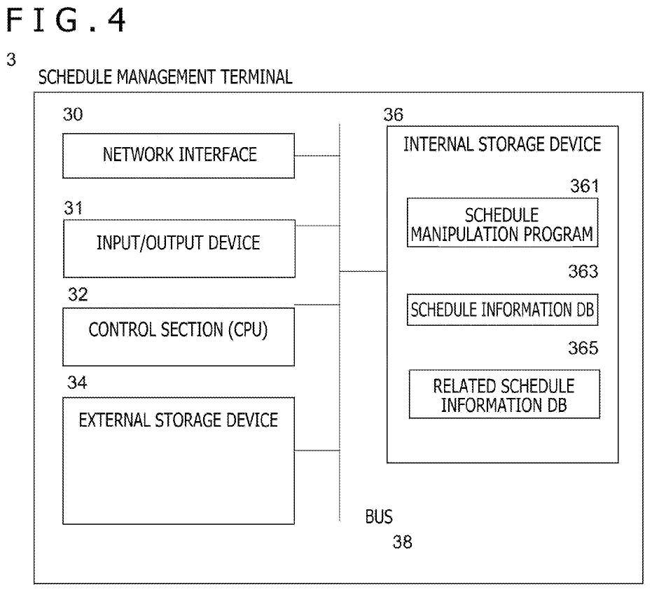

FIG. 4 illustrates an example structure of the schedule management terminals 3. The schedule management terminals 3 each include a control section (CPU) 32, a memory or other internal storage device 36, a hard disk or other external storage device 34, and a network interface 30. These component elements are connected to a bus 38. The schedule management terminals 3 communicate with the outside through the network interface 30. Further, a keyboard, a display, or other input/output device 31 is connected to the bus 38 in order to let the user variously manipulate the schedules.

The internal storage device 36 stores a schedule manipulation program 361, a schedule information database (DB) 363, and a related schedule information DB 365. The schedule manipulation program 361 implements schedule management functions such as schedule registration, update, and notification. The schedule information DB 363 manages information about, for example, the start time, end time, and contents of the schedules. The related schedule information DB 365 manages schedule information about persons and apparatuses related to the users.

The above-described databases may be stored in the external storage device 34 in consideration, for example, of the scale, data volume, and response speed of the schedule adjustment system. These databases are read and written by the schedule manipulation program 361 installed in the internal storage device 36. The schedule management terminals 3 provide the users with the schedule management functions when the control section (CPU) 32 accesses the schedule manipulation program 361 stored in the internal storage device 36.

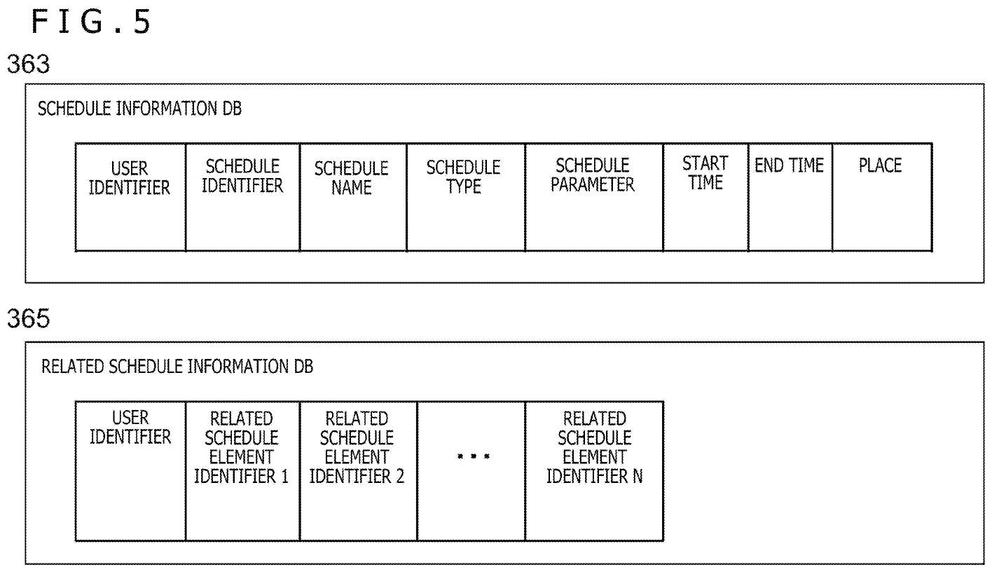

FIG. 5 illustrates an example structure of the databases existing in the internal storage device 36 of each of the schedule management terminals 3.

The basic function of the schedule management terminals 3 is to acquire data about a schedule from the schedule management server 1, display the acquired data on a screen, change, delete, or otherwise manipulate the schedule, and reflect the resulting latest data in the schedule management server 1. The data managed by the schedule management terminals 3 has the same structure as the data managed by the schedule management server 1. Therefore, the details of the data structure will not be redundantly described.

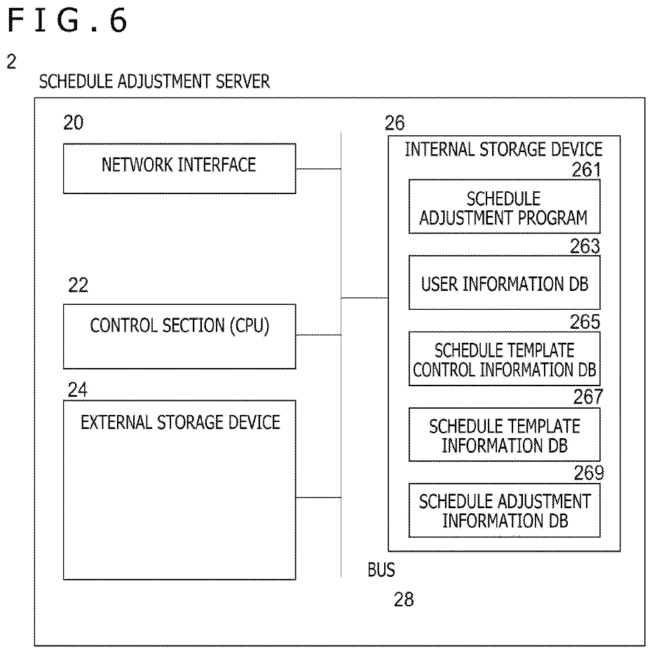

FIG. 6 illustrates an example device structure of the schedule adjustment server 2.

The schedule adjustment server 2 includes a control section (CPU) 22, a memory or other internal storage device 26, a hard disk or other external storage device 24, and a network interface 20. These component elements are connected to a bus 28. The schedule adjustment server 2 communicates with the outside through the network interface 20. The internal storage device 26 stores a schedule adjustment program 261 that provides a schedule adjustment function. The schedule adjustment program 261 is installed in the external storage device 14, and is started by the control section (CPU) 22 when the schedule adjustment system begins to operate.

In addition to the above-mentioned program, the schedule adjustment server 2 stores a user information DB 263, a schedule template control information DB 265, a schedule template information DB 267, and a schedule adjustment information DB 269. The user information DB 263 manages information related to the users of the schedule adjustment system. The schedule template control information DB 265 manages information for controlling the operations of schedule templates used for schedule adjustment. The schedule template information DB 267 manages information about the schedule templates. The schedule adjustment information DB 269 manages information about schedule adjustments that are executed by using the schedule templates.

Each of the above-described databases may be stored in the external storage device 24 in consideration, for example, of the scale, data volume, and response speed of the schedule adjustment system. The databases are read and written by the schedule adjustment program 261 installed in the internal storage device 26. When the control section (CPU) 22 accesses the schedule adjustment program 261 stored in the internal storage device 26, the schedule adjustment server 2 executes a schedule adjustment process.

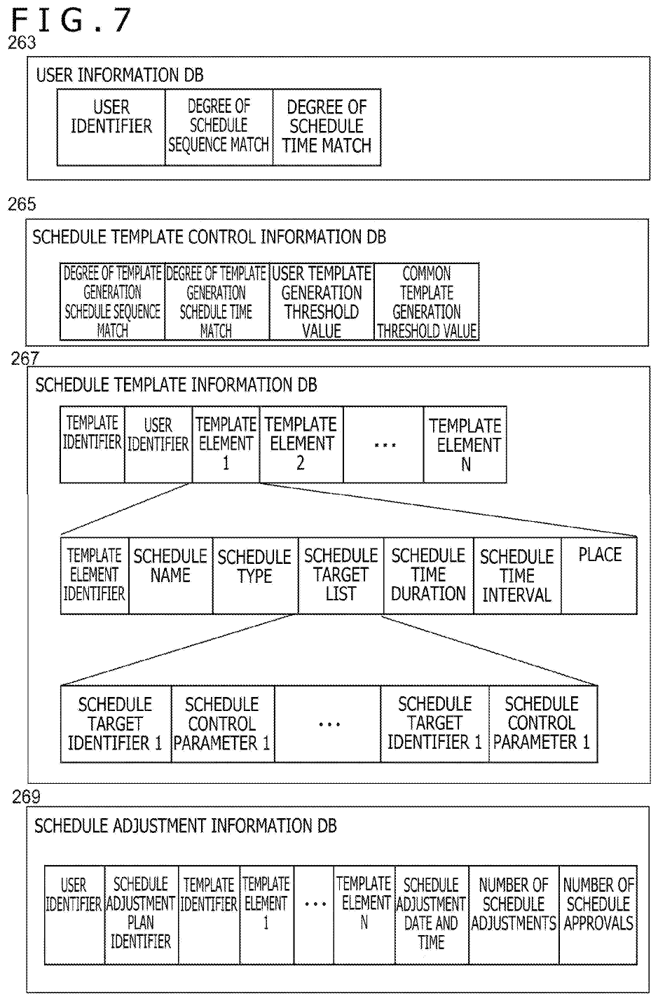

FIG. 7 illustrates an example structure of databases existing in the internal storage device 26 of the schedule adjustment server 2.

The user information DB 263 is a database for managing information about the degree of match between a schedule and a schedule template that are used for schedule adjustment by a user. The user information DB 263 contains the degree of schedule sequence match and the degree of schedule time match. The degree of schedule sequence match is the degree of match regarding a schedule sequence. The degree of schedule time match is the degree of match regarding a schedule time. The degree of match is typically managed by percentage.

The schedule template control information DB 265 is a database for managing various parameters that are used when the schedule adjustment server 2 generates a schedule template based on a past schedule of a user in the schedule adjustment system. The schedule template control information DB 265 contains the degree of template generation schedule sequence match, the degree of template generation schedule time match, a user template generation threshold value, and a common template generation threshold value. The degree of template generation schedule sequence match is the degree of match regarding a schedule sequence at the time of template generation. The degree of template generation schedule time match is the degree of match regarding a schedule time. The user template generation threshold value is used for generating a schedule template for a user. The common template generation threshold value is used for generating a schedule template to be used in common in the schedule adjustment system. The user template generation threshold value and the common template generation threshold value indicate the number of pieces of matched schedule data.

The schedule template information DB 267 is a database for managing schedule templates used for schedule adjustment. The schedule template information DB 267 contains a template identifier, a user identifier, and one or more template elements. The template identifier uniquely identifies a schedule template. The user identifier identifies a user to whom the schedule template is applied. The schedule template may be applied to a specific user or applied to all users in common in the schedule adjustment system. In the latter case, the value “common” is set for the user identifier to distinguish it from a user identifier indicative of a specific user.

The template elements represent schedule information including a template element identifier, a schedule name, a schedule type, a schedule target list, a schedule time duration, a schedule time interval, and a place where a schedule is executed. The schedule name is the name of the schedule. The schedule type indicates whether the schedule relates to a human target or a nonhuman target such as an apparatus or a service. The schedule target list indicates those related to schedule execution, such as a human, an apparatus, and a service. The schedule time interval indicates a time interval between the schedule and a subsequent schedule. A general name is designated as the schedule name. For example, in a case where a user inputs a schedule of a meeting in a company, the user generally adds a word indicating the contents of the meeting.

For example, in a case where a strategy meeting or a personnel meeting is to be held, the word “meeting,” which is a generic name of such a meeting, is designated as the schedule name, which is one of the template elements. The schedule target list indicates those related to schedule execution, such as a human, an apparatus, and a service. For example, the other users participating in the meeting, a meeting room, and, in some cases, equipment such as a projector as well, are required for a meeting. The schedule target list is a list of all targets related to the schedule and schedule control parameters used for controlling the targets. The schedule target list includes zero or more elements.

The schedule adjustment information DB 269 is a database for managing information about schedule adjustments executed by the schedule adjustment server 2. The schedule adjustment information DB 269 contains a user identifier, a schedule adjustment plan identifier, a template identifier, a list, the date and time of schedule adjustment execution, the number of schedule adjustments, and the number of schedule approvals. The user identifier identifies a target for which schedule adjustment is executed. The template identifier identifies a schedule template used for schedule adjustment. The list indicates one or more schedule elements included in a schedule adjustment plan generated based on the schedule template. The number of schedule approvals indicates the number of user approvals of schedule adjustment. The contents of the schedule elements are similar to those of the template elements.

Further, the schedule adjustment plan is a schedule plan prepared by the schedule adjustment server 2. Eventually, the user determines whether or not to accept the schedule adjustment plan. The number of times the schedule adjustment plan is presented to the user by the schedule adjustment server 2 is managed by the number of schedule adjustments, and the number of times the presented schedule adjustment plan is approved by the user is managed by the number of schedule approvals.

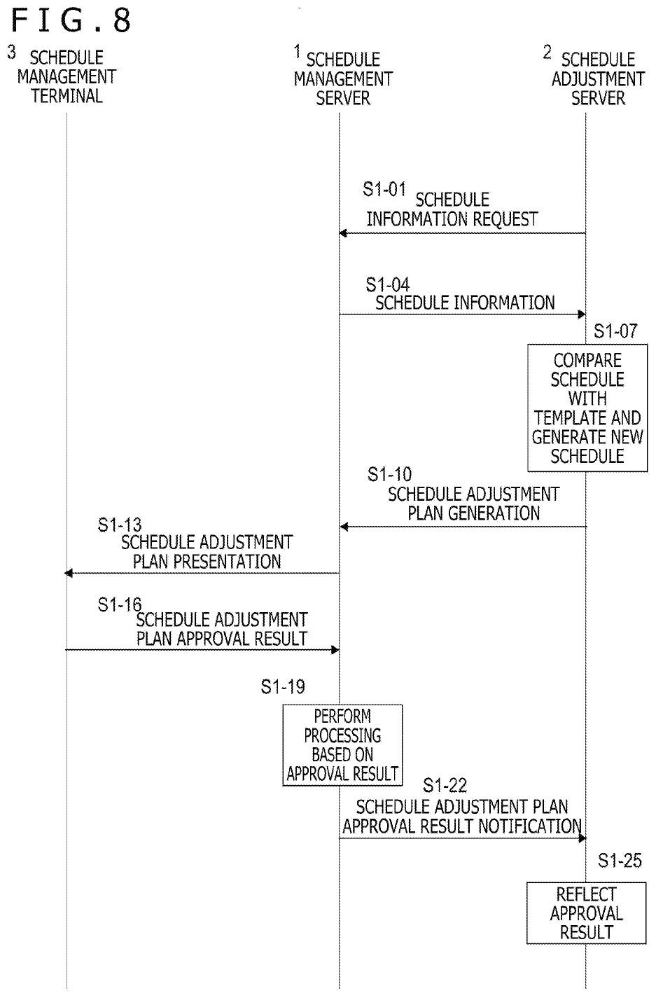

The overall operation of the schedule adjustment system according to the embodiment of the present invention will now be described. First of all, a process performed by the schedule adjustment server 2 to execute a schedule adjustment based on schedule templates will be described with reference to the time sequence diagram of FIG. 8.

The schedule adjustment process is a process of comparing the schedule information about a user with the schedule templates and suggesting a schedule plan to the user in accordance with a schedule template exhibiting a high degree of match. In the process, it is necessary to acquire the schedule information about the user. Therefore, the schedule adjustment server 2 transmits a schedule information request to the schedule management server 1 (S1-01).

Upon receiving the schedule information request from the schedule adjustment server 2, the schedule management server 1 transmits, to the schedule adjustment server 2, the schedule information about all users managed by the schedule management server 1 (S1-04). The transmitted schedule information is information that is managed by the schedule information DB 163 and not older than the date and time of schedule information request message reception. The reason is that schedule adjustment is made in order to suggest a future schedule, and that past data is not useful for schedule adjustment.

Upon receiving the schedule information from the schedule management server 1, the schedule adjustment server 2 compares the schedule information with the schedule templates to calculate the degree of match, generates a schedule adjustment plan (S1-07), and transmits the generated schedule adjustment plan to the schedule management server 1 (S1-10). The schedule adjustment plan includes the user identifier, schedule adjustment plan identifier, template identifier, and schedule element list in the schedule adjustment information DB 269.

Upon receiving the schedule adjustment plan, the schedule management server 1 transmits the schedule adjustment plan to a user associated with the user identifier (S1-13). Upon receiving the schedule adjustment plan through a schedule management terminal 3, the user examines the contents of the schedule adjustment plan, determines whether or not to accept the schedule adjustment, and notifies the schedule management server 1 of the result of determination by transmitting a schedule adjustment plan approval result (S1-16).

Upon receiving the schedule adjustment plan approval result, the schedule management server 1 performs a process based on the schedule adjustment plan approval result (S1-19). If “approval” is indicated by the schedule adjustment plan approval result, the schedule management server 1 determines the schedule adjustment plan as an approved plan, and registers the schedule adjustment plan in the schedule information DB 163. Meanwhile, if “rejection” is indicated by the schedule adjustment plan approval result, the schedule management server 1 discards the schedule adjustment plan and does not update the schedule information DB 163.

The schedule management server 1 transmits a schedule adjustment plan approval result notification to the schedule adjustment server 2 to notify the schedule adjustment server 2 of a user approval result (S1-22). Upon receiving the schedule adjustment plan approval result notification, the schedule adjustment server 2 updates the schedule adjustment information DB 269 by using the user approval result (S1-25).

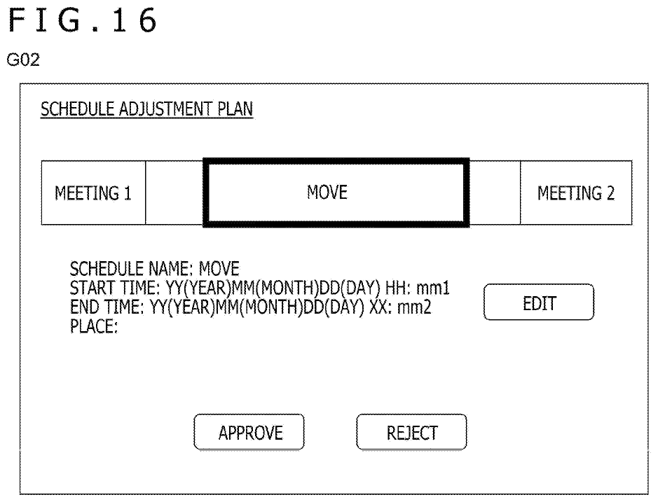

FIG. 16 depicts an example of a screen that presents a schedule adjustment plan to a user. In this example, the user is suggested that a schedule named “move” be newly generated between two meetings (meetings 1 and 2). The schedule adjustment plan presents, to the user, information about a schedule name, a start time, an end time, and a place. These items of information are generated by the schedule adjustment server 2 according to the schedule templates, and can be edited as needed by the user. When such an edit is performed, the user approval result and the result of editing are both transmitted to the schedule management server 1.

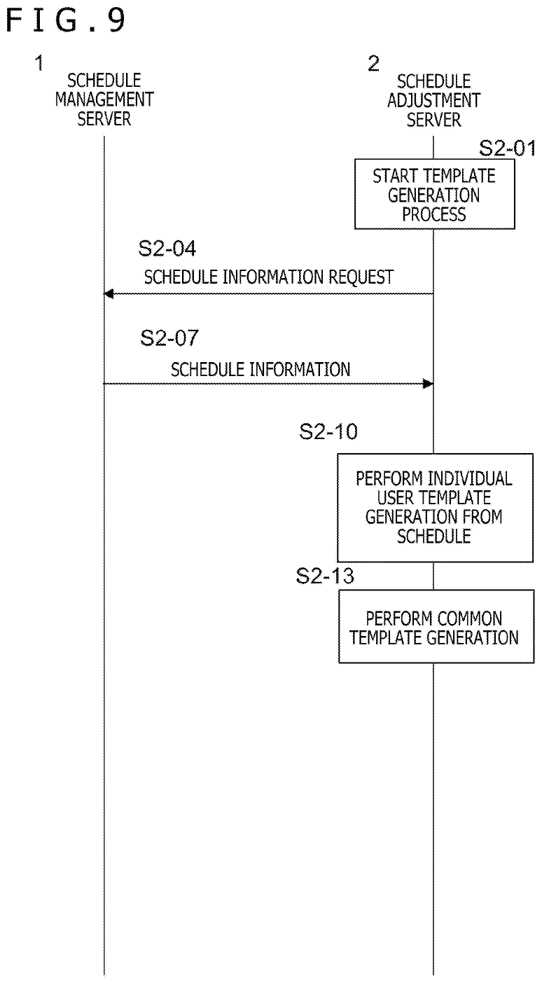

The schedule templates are prepared by the schedule adjustment server 2. However, it is desirable that the schedule information about users be acquired by system operations to generate the schedule templates in order to increase the flexibility of adjustment. FIG. 9 is a time sequence diagram illustrating an example of a schedule template generation process that is performed by the schedule adjustment server 2 to newly generate schedule templates based on the schedule information. When the schedule template generation process starts (S2-01), the schedule adjustment server 2 transmits a schedule information request to the schedule management server 1 (S2-04).

Upon receiving the schedule information request from the schedule adjustment server 2, the schedule management server 1 transmits, to the schedule adjustment server 2, the schedule information about all users managed by the schedule management server 1 (S2-07). The transmitted schedule information is the whole schedule information including past data that is managed by the schedule information DB 163.

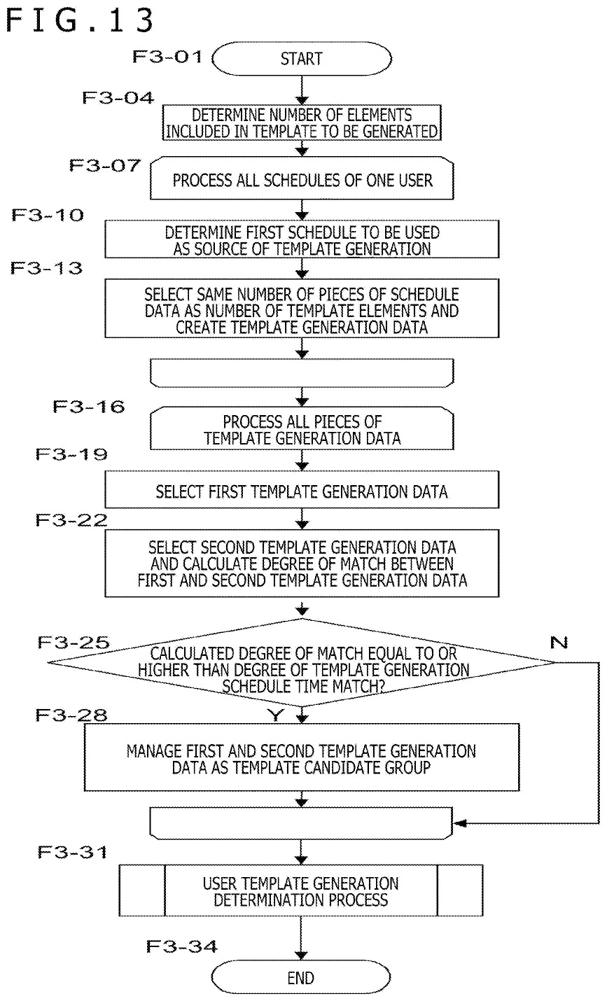

The reason is that previously executed schedule data can also be used for schedule template generation. In the schedule template generation process, a schedule template generation process for an individual user (S2-10) and a common schedule template generation process (S2-13) are performed in sequence. These processes will be described in detail with reference to the flowcharts of FIGS. 13, 14, and 15.

The schedule adjustment and the schedule template generation process will now be described in detail with reference, for example, to the flowcharts.

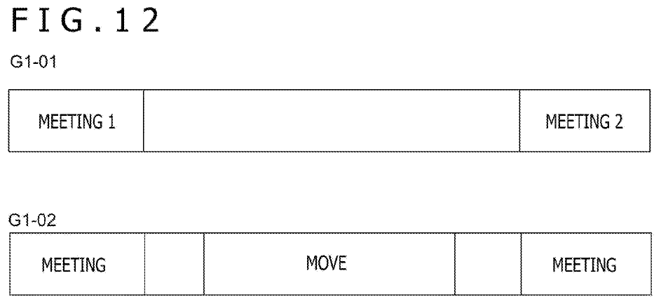

First of all, the calculation of the degree of match between the schedule information and the schedule templates will be described with reference to a conceptual diagram of FIG. 12. FIG. 12 illustrates an example of a schedule (G1-01) and an example of a schedule template (G1-02). The schedule is expressed by a concrete schedule name, a schedule start time, and a schedule end time. The example in FIG. 12 indicates that the schedule management server 1 manages two schedules, namely, meeting 1 between 9:00 and 10:00 and meeting 2 between 13:00 and 14:00.

Meanwhile, the schedule template is not managed according to the start time and the end time, but is managed according to a schedule time duration and a schedule time interval between one schedule and the next. In the schedule template (G1-02) depicted in FIG. 12, a first schedule element is a meeting that has a time duration of 1 hour, a second schedule element is a move that begins 30 minutes after the end of the first schedule element and has a time duration of 1 hour and 30 minutes, and a third schedule element is a meeting that begins 30 minutes after the end of the second schedule element and has a time duration of 1 hour and 30 minutes. When the degree of match between the schedule and the schedule template is to be calculated, attention is initially focused on the correspondence between the sequences of schedule elements.

In the example of FIG. 12, the meetings are included in both the schedule and the schedule template. The schedule template includes the move between the meetings. However, the schedule does not include any move. In this case, therefore, the degree of sequence match is ⅔, that is, approximately 67%, because the schedule elements correspond to two of the three schedule template elements. Next, the degree of time duration match between the schedule elements and the corresponding schedule template elements is calculated.

In the example of FIG. 12, meeting 1, which is scheduled to begin at 9:00, corresponds to the 1-hour meeting at the beginning of the schedule template. Further, meeting 2, which is scheduled to begin at 13:00, corresponds to the 1-hour and 30-minute meeting at the end of the schedule template. Meeting 1 and the meeting at the beginning of the schedule template match in duration because they both have a time duration of 1 hour. Therefore, the calculated degree of time duration match between meeting 1 and the schedule template is 100%. Meanwhile, meeting 2 and the meeting at the end of the schedule template have a time duration of 1 hour and a time duration of 1 hour and 30 minutes, respectively. In this case, the degree of time duration match is calculated by dividing 1 hour by 1 hour and 30 minutes. That is to say, the calculated degree of time duration match is approximately 67%. As regards the degree of time duration match, the average value of the degrees of time duration match between the schedule elements and the corresponding schedule template elements is adopted.

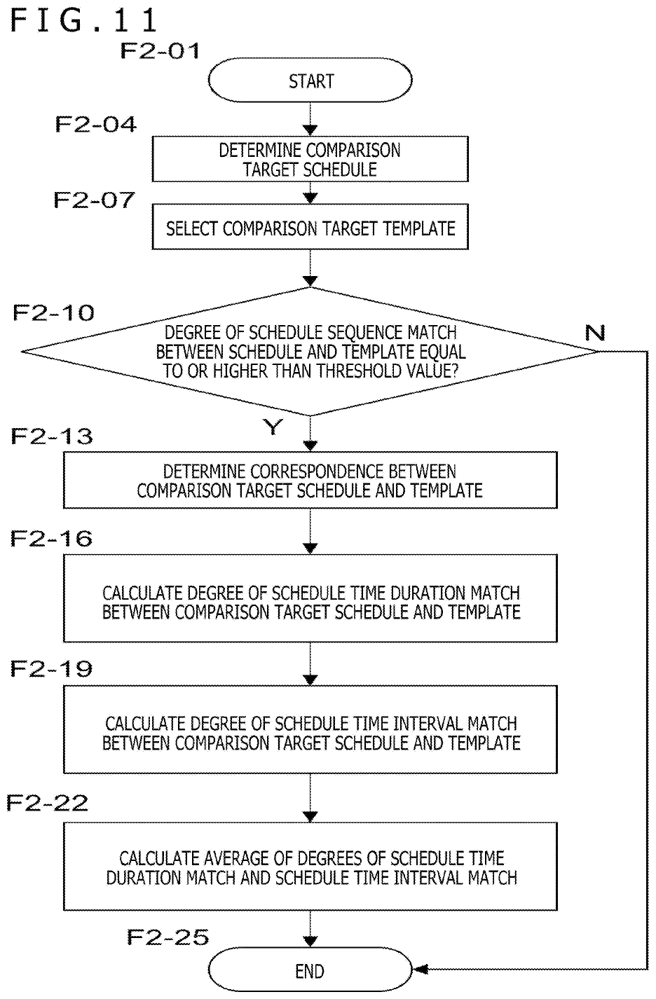

In the example of FIG. 12, the average of the two calculated values, namely, 100% and 67%, is 83.5%. Eventually, the degree of time duration match is 83.5%. The flowchart of FIG. 11 illustrates an example method of calculating the degree of match between a schedule and a schedule template.

The calculation of the degree of match between a schedule and a schedule template is started by selecting a comparison target schedule (F2-04) and selecting a comparison target schedule template (F2-07). First of all, the degree of schedule sequence match between the schedule and the schedule template is calculated by a method illustrated in FIG. 12 (F2-10). If the calculated degree of schedule sequence match is lower than the degree of schedule sequence match contained in the user information DB 263 or the degree of template generation schedule sequence match contained in the schedule template control information DB 265, the subsequent calculation steps are not performed because the degree of match is judged to be lower than a threshold value. The value to be used for judgment is determined depending on whether the schedule adjustment process or the schedule template generation process is to be executed.

If the degree of schedule sequence match is equal to or higher than the threshold value, the degree of schedule time duration match between the comparison target schedule and the schedule template is calculated from the correspondence of schedules between the comparison target schedule and the schedule template (F2-16). Next, the degree of schedule time interval match between the schedule and the corresponding schedule template is calculated (F2-19). Eventually, the average of all the calculated degrees of schedule time duration match and schedule time interval match is regarded as the final degree of schedule match.

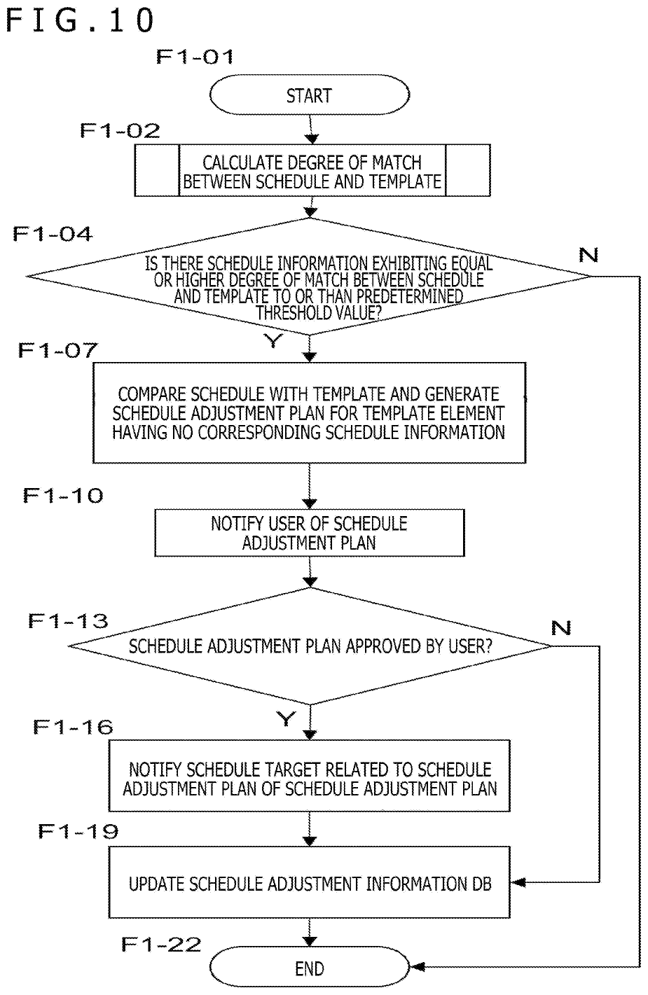

FIG. 10 is a flowchart illustrating an example of the schedule adjustment process based on a schedule template.

One piece of the schedule information and one schedule template are selected from those acquired from the schedule management server 1, and then the degree of schedule match between the selected schedule information and the schedule template is calculated (F1-04). If the calculated degree of schedule match is lower than the degree of schedule sequence match contained in the user information DB 263, the schedule adjustment process is not performed, and another combination of schedule information and schedule template is tried. Meanwhile, if the calculated degree of schedule match is equal to or higher than the degree of schedule sequence match contained in the user information DB 263, the schedule is compared with the schedule template, and the schedule adjustment plan is generated for a schedule template element having no corresponding schedule information (F1-07).

In the example of FIG. 12, there is no schedule information corresponding to the schedule template element named “move.” Therefore, the schedule adjustment plan is generated for the schedule template element named “move.” The schedule adjustment plan is generated in consideration, for example, of the schedule time duration, time interval, and place. After the schedule adjustment plan is generated, the schedule adjustment server 2 and the schedule management server 1 notify a target user of the generated schedule adjustment plan (F1-10).

Upon receiving the schedule adjustment plan, the user checks the contents of the schedule adjustment plan for appropriateness, and determines whether or not to approve the schedule adjustment plan (F1-13). If the schedule adjustment plan is approved by the user, the schedule management server 1 registers the approved schedule adjustment plan in the schedule information DB 163 as the schedule information (F1-16), and the schedule adjustment server 2 updates the schedule adjustment information DB 269 (F1-19). Meanwhile, if the schedule adjustment plan is not approved by the user, the schedule management server 1 does nothing, and the schedule adjustment server 2 updates the schedule adjustment information DB 269 (F1-19).

Examples of processes performed to generate a schedule template from a user schedule will now be described with reference to the flowcharts of FIGS. 13 to 15.

Schedule template generation is performed by detecting a pattern repeated in the schedules of one or more users, performing a threshold value process, and registering the result of the threshold value process as a schedule template. First of all, the number of schedules to be included in a schedule template is determined (F3-04). The reason is that, if the number of template elements registered in the schedule template information DB 267 is not determined, for example, the subsequent calculation of the degree of match cannot be performed. One or more natural numbers may be designated as desired as the number of template elements. After the number of schedules is determined, the following processing steps are repeatedly performed on the whole schedule information about a user (F3-07).

First of all, the first schedule data in a template generation determination process is selected (F3-10). Next, the same number of pieces of schedule information as the number of schedules determined in step F3-04 are selected in the time axis direction from the schedule information selected in step F3-10 to create template generation data (F3-13).

The above processing is performed on the whole schedule information to create the template generation data including the same number of pieces of schedule information as the number of schedule template elements to be generated. Next, the following processing steps are repeatedly performed on all the created template generation data (F3-16). First of all, the first template generation data is selected (F3-19).

Next, the second template generation data is selected to calculate the degree of schedule match between the second template generation data and the first template generation data according to the flowchart of FIG. 11 (F3-22). Here, the threshold value used in step F2-10 is the degree of template generation schedule sequence match, which is contained in the schedule template control information DB 265. The degree of schedule match between the two calculated pieces of template generation data is then compared with the degree of template generation schedule time match, which is contained in the schedule template control information DB 265 (F3-25). If the degree of schedule match between the two calculated pieces of template generation data is higher than the degree of template generation schedule time match, the two selected pieces of template generation data are grouped as a template candidate group for management purposes (F3-28).

If one of the selected pieces of template generation data is already grouped into a different template candidate group for management purposes, the template generation data is added to such an existing template candidate group. A group of schedule data exhibiting a degree of schedule match that is equal to or higher than the threshold value is created in the above-described manner. The template candidate group generated in step F3-28 is used to perform the schedule template generation process on a user who has supplied the original of the template generation data (F3-31).

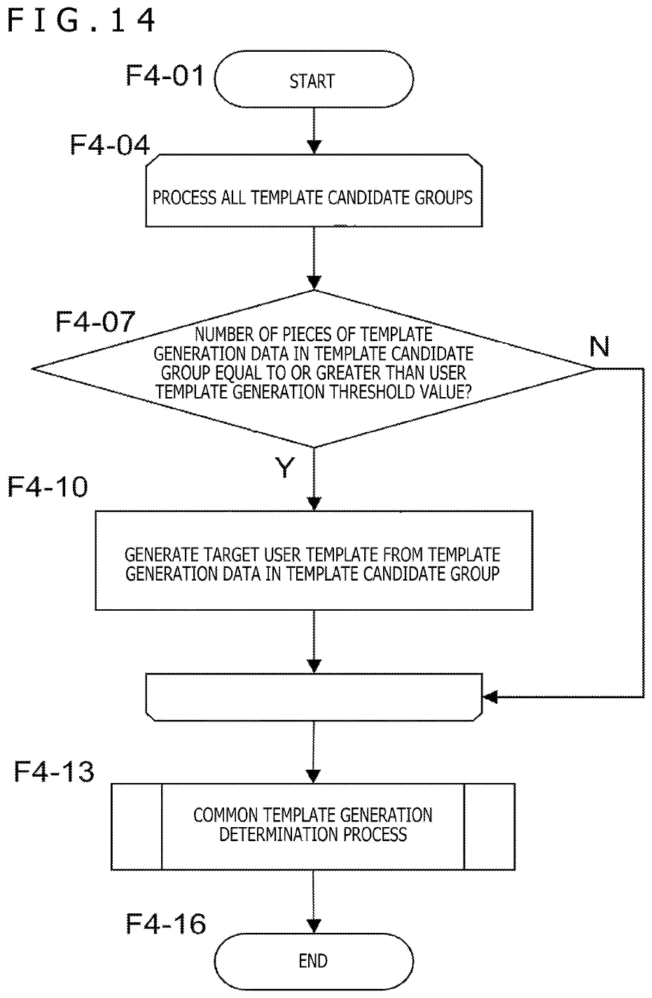

An example of a user template generation process based on a template candidate group will be described with reference to the flowchart of FIG. 14. The user template generation process is performed on all template candidate groups generated in step F3-28 of FIG. 13 (F4-04).

The template candidate groups each include two or more pieces of template generation data. Therefore, the number of pieces of template generation data included in a template candidate group is compared with the user template generation threshold value contained in the schedule template control information DB 265 (F4-07). If the number of pieces of template generation data included in the template candidate group is equal to or greater than the user template generation threshold value, a new schedule template is generated based on the template generation data included in the template candidate group as a template for the user who has supplied the original of the template generation data (F4-10). After a user schedule template generation determination is made for all the template candidate groups, a common template generation determination process is performed on a common template used in common in the schedule adjustment system (F4-13).

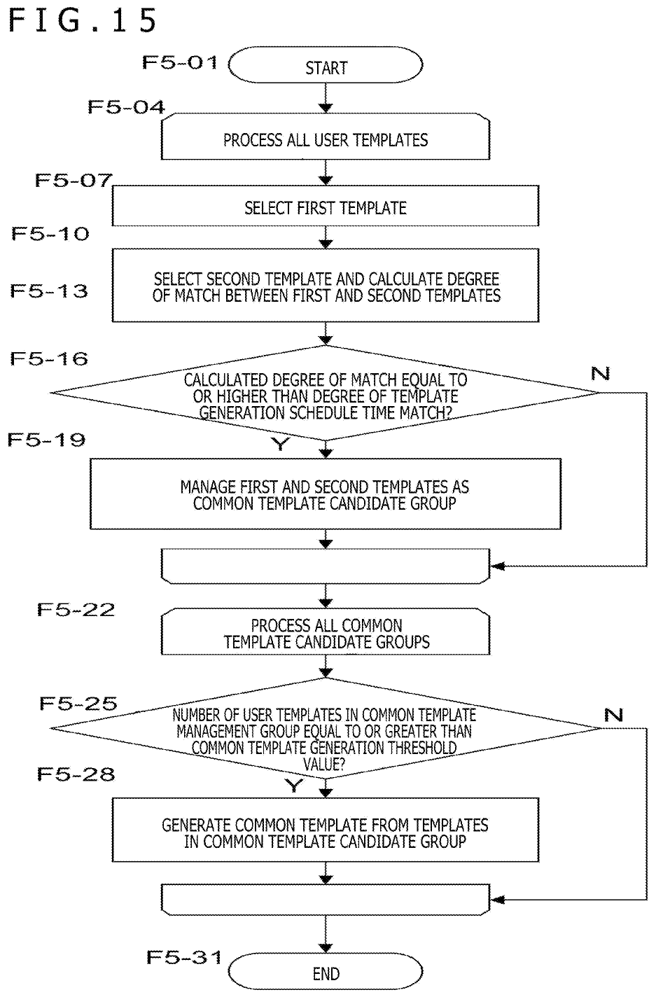

FIG. 15 is a flowchart illustrating an example of a common template generation process. The common template generation process is performed on all user schedule templates of all users (F5-04).

First of all, a first user schedule template is selected as a source of common template generation (F5-07). Next, a second user schedule template is selected to calculate the degree of schedule match between the first user schedule template and the second user schedule template according to the flowchart of FIG. 11 (F5-10).

Here, the degree of template generation schedule sequence match contained in the schedule template control information DB 265 is used as the threshold value in step F2-10. The degree of schedule match between the two calculated user schedule templates is compared with the degree of template generation schedule time match contained in the schedule template control information DB 265 (F5-16). If the degree of schedule match between the two user schedule templates is higher than the degree of template generation schedule time match, the two selected user schedule templates are grouped as a common template candidate group for management purposes (F5-19). If one of the user schedule templates is already grouped into a different common template candidate group for management purposes, the user schedule template is added to such an existing common template candidate group.

A group of user schedule templates exhibiting a degree of schedule match that is equal to or higher than the threshold value is created in the above-described manner. All the common template candidate groups generated in step F5-19 are used to perform the common template generation process of the schedule adjustment system (F5-22). The common template candidate groups each include two or more user schedule templates. Therefore, the number of user schedule templates included in a common template candidate group is compared with the common template generation threshold value contained in the schedule template control information DB 265 (F5-25).

If the number of pieces of template generation data included in a template candidate group is equal to or greater than the user template generation threshold value, a new common schedule template is generated based on the user schedule templates included in the common template candidate group as a common template for all users in the schedule adjustment system (F5-28). After a common template generation determination is made for all the common template candidate groups, the template generation process terminates (F5-31).

In the above-described embodiment, the patterns of automatic schedule generation are registered in the schedule adjustment system as schedule templates, the schedule templates are collated with future action plans of users, and future schedules are suggested. Further, in the above-described embodiment, the schedule templates are generated from inferred schedules and the history of execution of such schedules, and the schedule templates are improved so as to be widely shared among the users of the schedule adjustment system.

The above-described embodiment enables automatic schedule generation without relying on a person's past action history through the use of schedule templates preregistered in the schedule adjustment system. Further, the above-described embodiment enables the number of use cases for the automatic schedule generation to be increased automatically and continuously by improving the schedule templates in consideration of the action history of the users of the schedule adjustment system.

Thus, according to the above-described embodiment, the management of schedules concerning a plurality of persons, apparatuses, and services is semi-automated, and thus the time required for schedule management is reduced.

The schedule adjustment system according to the embodiment of the present invention is widely applicable to schedule services that manage and adjust the schedules of a plurality of persons and apparatuses.

What is claimed is:

1. A schedule adjustment device for generating a schedule adjustment plan from schedule information indicating a schedule of a user; the schedule adjustment device comprising:
a storage device that stores schedule template information indicative of a template of the schedule; and
a control section that compares the schedule information with the schedule template information and generates the schedule adjustment plan.

2. The schedule adjustment device according to claim 1, wherein
the control section
calculates degree of schedule match between the schedule information and the schedule template information, and
determines based on the degree of schedule match whether or not to generate the schedule adjustment plan.

3. The schedule adjustment device according to claim 2, wherein,
the control section generates the schedule adjustment plan when the degree of schedule match is equal to or higher than a predetermined threshold value.

4. The schedule adjustment device according to claim 2, wherein
the control section uses degree of schedule sequence match and degree of schedule time match as the degree of schedule match in order to determine whether or not to generate the schedule adjustment plan, the degree of schedule sequence match being used to define a sequence of the schedule, the degree of schedule time match being used to define a time of the schedule.

5. The schedule adjustment device according to claim 4, wherein
the control section uses degree of schedule time duration match and degree of schedule time interval match in order to determine whether or not to generate the schedule adjustment plan, the degree of schedule time duration match being related to a time duration of the schedule, the degree of schedule time interval match being related to a time interval between a pair of the schedules.

6. The schedule adjustment device according to claim 1, wherein
the control section
analyzes an action pattern of the user on a basis of the schedule information, and
newly generates, as specific user schedule template information for the user, the schedule information having the action pattern executed when a predetermined threshold value is reached or exceeded.

7. The schedule adjustment device according to claim 6, wherein
the control section
calculates degree of schedule template information match between first user schedule template information and second user schedule template information from among a plurality of pieces of the newly generated user schedule template information, and
uses the degree of schedule template information match to determine whether or not to generate common schedule template information for a plurality of the users.

8. A schedule adjustment system comprising:
a schedule management terminal; and
a schedule adjustment server that is connected to the schedule management terminal through a network, wherein
the schedule management terminal
stores schedule information indicating a schedule of a user, and the schedule adjustment server
stores schedule template information indicating a template of the schedule, and
compares the schedule information with the schedule template information in order to generate the schedule adjustment plan.

9. The schedule adjustment system according to claim 8, wherein
the schedule adjustment server
calculates degree of schedule match between the schedule information and the schedule template information, and
uses the degree of schedule match to determine whether or not to generate the schedule adjustment plan.

10. The schedule adjustment system according to claim 9, wherein
the schedule adjustment server generates the schedule adjustment plan when the degree of schedule match is equal to or higher than a predetermined threshold value.

11. The schedule adjustment system according to claim 9, wherein
the schedule adjustment server uses degree of schedule sequence match and degree of schedule time match as the degree of schedule match in order to determine whether or not to generate the schedule adjustment plan, the degree of schedule sequence match being used to define a sequence of the schedule, the degree of schedule time match being used to define a time of the schedule.

12. The schedule adjustment system according to claim 11, wherein
the schedule adjustment server uses degree of schedule time duration match and degree of schedule time interval match as the degree of schedule time match in order to determine whether or not to generate the schedule adjustment plan, the degree of schedule time duration match being related to a time duration of the schedule, the degree of schedule time interval match being related to a time interval between a pair of the schedules.

13. The schedule adjustment system according to claim 8, wherein
the schedule adjustment server
analyzes an action pattern of the user on a basis of the schedule information, and
newly generates, as specific user schedule template information for the user, the schedule information having the action pattern executed when a predetermined threshold value is reached or exceeded.

14. The schedule adjustment system according to claim 13, wherein
the schedule adjustment server
calculates degree of schedule template information match between first user schedule template information and second user schedule template information from among a plurality of pieces of the newly generated user schedule template information, and
uses the degree of schedule template information match to determine whether or not to generate common schedule template information for a plurality of the users.

15. The schedule adjustment system according to claim 8, wherein
the schedule adjustment server
presents the schedule adjustment plan to the schedule management terminal,
the schedule management terminal
displays the schedule adjustment plan, and
notifies the schedule adjustment server of a result of approval of the displayed schedule adjustment plan, and
the schedule adjustment server reflects the result of approval of the displayed schedule adjustment plan.

16. The schedule adjustment system according to claim 8, wherein
a schedule management server for providing centralized management of the schedule of the user is further connected to the network,
the schedule management server stores the schedule information,
the schedule adjustment server demands the schedule information from the schedule management server,
the schedule management server sends, in response to the demand, the schedule information to the schedule adjustment server, and
the schedule adjustment server generates the schedule adjustment plan by using the schedule information.

17. A schedule adjustment method for generating a schedule adjustment plan from schedule information indicating a schedule of a user, and presenting the generated schedule adjustment plan to the user, the schedule adjustment method comprising:
a storage step of storing schedule template information indicative of a template of the schedule;
a schedule adjustment plan generation step of comparing the schedule information with the schedule template information and generating the schedule adjustment plan; and
a display step of displaying the schedule adjustment plan.

18. The schedule adjustment method according to claim 17, wherein
the schedule adjustment plan generation step
calculates degree of schedule match between the schedule information and the schedule template information, and
determines, based on the degree of schedule match, whether or not to generate the schedule adjustment plan.

19. The schedule adjustment method according to claim 18, wherein
the schedule adjustment plan generation step generates the schedule adjustment plan when the degree of schedule match is equal to or higher than a predetermined threshold value.

20. The schedule adjustment method according to claim 18, wherein
the schedule adjustment plan generation step uses degree of schedule sequence match and degree of schedule time match as the degree of schedule match in order to determine whether or not to generate the schedule adjustment plan, the degree of schedule sequence match being used to define a sequence of the schedule, the degree of schedule time match being used to define a time of the schedule.
